(19) United States
(12) Patent Application Publication
(10) Pub. No.: US 2026/0063902 A1
(43) Pub. Date: Mar. 5, 2026

(54) EYE TRACKING OPTICAL DEVICE, SYSTEM AND VIRTUAL REALITY APPARATUS

(71) Applicant: BEIJING 7INVENSUN TECHNOLOGY CO., LTD., Beijing (CN)

(72) Inventors: Tongbing HUANG, Beijing (CN); Juanjuan SHANG, Beijing (CN); Wenbo FEI, Beijing (CN)

(73) Assignee: BEIJING 7INVENSUN TECHNOLOGY CO., LTD., Beijing (CN)

(21) Appl. No.: 18/878,032

(22) PCT Filed: Jun. 20, 2023
(86) PCT No.: PCT/CN2023/101518

§ 371 Date: Nov. 5, 2025

(30) Foreign Application Priority Data
Jun. 21, 2022 (CN) 202210706576.4

(51) Int. Cl. G02B 27/01; G02B 13/00; G02B 27/00

(52) U.S. Cl. CPC G02B 27/0172; G02B 13/005; G02B 13/007; G02B 13/008; G02B 27/0093; G02B 27/0176; G02B 2027/0138; G02B 2027/015

(57) ABSTRACT

An eyeball tracking optical device and system, and a virtual reality device is provided. In the device, a lens assembly includes a first and second lens portion sequentially disposed away from the eyeball forming a lens. A side face of the first lens portion has a concave face. A side face of the second lens portion has a convex face. Both attach to form a bonding face that is provided with a first reflection layer. A reflection assembly is located close to an image collection assembly. A light source assembly emits a first light ray to the eyeball. The first reflection layer reflects a reflection light ray to form a first reflection light ray. The reflection assembly is disposed to reflect the first reflection light ray at least once to form a light ray to be imaged and collected by the image collection assembly to track the eyeball.

### CROSS-REFERENCE TO RELATED APPLICATIONS

This application is a National Stage Entry under 35 U.S.C. § 371 of PCT International Application No. PCT/CN2023/101518, filed on Jun. 20, 2023, which claims priority to Chinese Patent Application No. 202210706576.4 filed on Jun. 21, 2022 and entitled “Eyeball Tracking Optical Device and System, and Virtual Reality Device”, the entire contents of each of which are incorporated herein by reference for all purposes.

### TECHNICAL FIELD

The present disclosure relates to the technical field of optics, in particular to an eyeball tracking optical device and system, and a virtual reality device.

### BACKGROUND

An eyeball tracking technology may be realized by an optical recording method. The principle of the optical recording method is that movement of eyes of a tested person is recorded by using an infrared camera, namely, an image of the eyes which may reflect movement of the eyes is acquired, and features of the eyes are extracted from the obtained image of the eyes to establish an estimation model of sight. The features of the eyes may include: a pupil location, a pupil shape, an iris location, an iris shape, an eyelid location, a canthus location, a facula location (or a purkinje image), and the like. The optical recording method includes a pupil-cornea reflection method. The principle of the pupil-cornea reflection method is that a near-infrared light source irradiates the eyes, the infrared camera shoots the eyes, and meanwhile, a reflection point, on the cornea, of the light source, namely, a facula is shot, so that an image of the eyes with the facula is acquired.

At present, an eyeball tracking recognition device applied to virtual reality glasses and augmented reality glasses is composed of an image collection part and a purkinje image mapping part. The image collection part tracks the location of the eyeball mainly by collecting the reflection facula of the eyeball 2, and in a common application scene, collection is carried out by mainly using the following solution.
(1) As shown in FIG. 1, an image collector 3 carries out image collection by directly transmitting an ocular lens 1.
(2) As shown in FIG. 2, the image collector 3 carries out image collection by utilizing surface reflection of other lenses 4 inside and then by transmitting the ocular lens 1.
(3) As shown in FIG. 3, the image collector 3 carries out image collection by adding a reflector 4 inside and then by transmitting the ocular lens 1.
(4) As shown in FIG. 4, a light path is first incident into the ocular lens 1 and reflected on the outer surface of the ocular lens 1, and the image collector 3 carries out image collection.

In the above collection solution, adding of the lens may enlarge the integral size of the device, meanwhile, reflection light ray of the eyeball 2 is easily completely reflected on the surface of the ocular lens 1 or the surface of the added lens, so that the image collector 3 cannot collect reflection light ray of the eyeball 2, and then the eyeball cannot be tracked.

### SUMMARY

The present disclosure provides an eyeball tracking optical device and system, and a virtual reality device, for solving the problem of total reflection of the reflection light ray of the eyeball on the basis of not enlarging the integral size of the device.

In order to realize the above objective, in an aspect of the present disclosure, an embodiment provides an eyeball tracking optical device, which includes a light source assembly, a lens assembly, a reflection assembly and an image collection assembly.

The lens assembly includes a first lens portion and a second lens portion which are sequentially disposed away from an eyeball, a side face, away from the eyeball, of the first lens portion has a concave face, a side face, close to the eyeball, of the second lens portion has a convex face, the concave face and the convex face attach to form a bonding face, the bonding face is provided with a first reflection layer, and the first lens portion and the second lens portion form a bonding lens.

The reflection assembly is located at a position, close to the image collection assembly, of the lens assembly.

The light source assembly is disposed to emit a first light ray to the eyeball, the first reflection layer is disposed to reflect a reflection light ray of the first light ray to form a first reflection light ray, and the reflection assembly is disposed to reflect the first reflection light ray at least once to form a light ray to be imaged.

The image collection assembly is disposed to collect the light ray to be imaged, so as to track the eyeball.

According to one embodiment of the present disclosure, the reflection assembly includes a second reflection layer, and the second reflection layer attaches to a part of a surface of a side, close to the eyeball, of the first lens portion.

According to one embodiment of the present disclosure, the second reflection layer is located in a non-visible area of the lens assembly.

According to one embodiment of the present disclosure, the reflection assembly further includes at least one of a reflection prism, a reflection plane mirror and a reflection curved mirror, and is disposed to adjust a direction of a second reflection light ray formed by reflection from the second reflection layer, so as to form the light ray to be imaged.

According to one embodiment of the present disclosure, one of the reflection prism, the reflection plane mirror and the reflection curved mirror is disposed fixedly attaching to the first lens portion.

According to one embodiment of the present disclosure, a diameter of the concave face or the convex face is greater than or equal to a diameter of a visible area of the lens assembly.

According to one embodiment of the present disclosure, the light source assembly is an infrared light source assembly, the first reflection layer is an infrared reflection layer, and the reflection assembly is an infrared reflection assembly.

According to one embodiment of the present disclosure, the image collection assembly includes one of a COMS or CCD photosensitive chip.

In order to realize the above objective, in a second aspect of the present disclosure, an embodiment provides an eyeball tracking optical system, which includes two eyeball tracking optical devices of any embodiment of the present disclosure, a left eye viewing assembly and a right eye viewing assembly.

One eyeball tracking optical device is mounted on the left eye viewing assembly.

The other eyeball tracking optical device is mounted on the right eye viewing assembly.

The left eye viewing assembly and the right eye viewing assembly are symmetrically distributed left and right.

In order to realize the above objective, in a third aspect of the present disclosure, an embodiment provides a virtual reality device, which includes the eyeball tracking optical system provided by the present disclosure.

According to the eyeball tracking optical device and system, and the virtual reality device provided by the present disclosure, the eyeball tracking optical device includes the light source assembly, the lens assembly, the reflection assembly and the image collection assembly; the lens assembly includes the first lens portion and the second lens portion which are sequentially disposed away from the eyeball, one side face, away from the eyeball, of the first lens portion has a concave face, one side face, close to the eyeball, of the second lens portion has a convex face, the concave face and the convex face attach to form the bonding face, the bonding face is provided with the first reflection layer, and the first lens portion and the second lens portion form the bonding lens; the reflection assembly is located at the position, close to the image collection assembly, of the lens assembly; the light source assembly is disposed to emit the first light ray to the eyeball, the first reflection layer is disposed to reflect the reflection light ray of the first light ray to form the first reflection light ray, and the reflection assembly is disposed to reflect the first reflection light ray at least once to form the light ray to be imaged; and the image collection assembly is disposed to collect the light ray to be imaged, so as to track the eyeball. Therefore, by disposing the lens in the original lens assembly as the bonding lens and disposing the bonding face as the first reflection layer, the reflection light ray of the first light ray may be reflected to form the first reflection light ray, then the reflection assembly reflects the first reflection light ray at least once to form the light ray to be imaged, which are incident into the image collection assembly, so that the problem that originally, in the image collection part, the reflection light ray of the first light ray is easily completely reflected by the ocular lens or the added lens, and the image collection assembly cannot collect the light ray to be imaged is solved.

It should be understood that the content described in this part is not intended to identify key or critical features of the embodiments of the present disclosure, nor is it intended to limit the scope of the present disclosure. Other features of the present disclosure will become apparent from the following specification.

### BRIEF DESCRIPTION OF THE DRAWINGS

In order to describe the technical solutions in the embodiments of the present disclosure more clearly, the drawings required to be used in descriptions about the embodiments will be simply introduced below, obviously, the drawings described below are only some embodiments of the present disclosure, and other drawings may further be obtained by those of ordinary skill in the art according to the drawings without creative work.

FIG. 1 is a diagram of a light path of light ray to be imaged in the related technology.

FIG. 2 is another diagram of a light path of light ray to be imaged in the related technology.

FIG. 3 is still another diagram of a light path of light ray to be imaged in the related technology.

FIG. 4 is yet another diagram of a light path of light ray to be imaged in the related technology.

FIG. 5 is a principle diagram of a light path of an eyeball tracking optical device provided by the present disclosure.

FIG. 6 is a diagram in a front view of a lens assembly in an eyeball tracking optical device provided by the present disclosure.

FIG. 7 is a principle diagram of a light path of an eyeball tracking optical device provided by another embodiment of the present disclosure.

FIG. 8 is a principle diagram of a light path of an eyeball tracking optical device provided by still another embodiment of the present disclosure.

FIG. 9 is a principle diagram of a light path of an eyeball tracking optical device provided by yet another embodiment of the present disclosure.

FIG. 10 is a schematic block diagram of an eyeball tracking optical system provided by the present disclosure.

FIG. 11 is a schematic block diagram of a virtual reality device provided by the present disclosure.

### DESCRIPTION OF REFERENCE NUMERALS

100. Eyeball tracking optical device; 101. Light source assembly; 102. Lens assembly; 1021. First lens portion; 1022. Second lens portion; 1023. First reflection layer; 1024. Non-visible area; 1025. Visible area; 103. Reflection assembly; 1031. Second reflection layer; 1032. Reflection prism; 1033. Reflection plane mirror; 1034. Reflection curved mirror; 104. Image collection assembly; 105. Eyeball; 106. First light ray; 107. Reflection light ray; 108. First reflection light ray; 109. Light ray to be imaged; 110. Second reflection light ray; 200. Eyeball tracking optical system; 201. Left eye viewing assembly; 202. Right eye viewing assembly; and 300. Virtual reality device.

### DETAILED DESCRIPTION OF THE EMBODIMENTS

In order to enable those skilled in the art to better understand the solution of the present disclosure, the technical solution in the present disclosure will be described clearly and completely in conjunction with the drawings in the present disclosure. Obviously, the described embodiments are a part of, but not all of the present disclosure. All other embodiments obtained by those of ordinary skill in the art based on the embodiments of the present disclosure without creative efforts shall fall within the protection scope of the present disclosure.

It is to be noted that the terms “first,” “second,” and the like in the specification, the claims and the drawings of the present disclosure are used for distinguishing between similar objects and not necessarily for describing a particular sequence or sequential order. It will be appreciated that such data may be interchangeable where appropriate, so that the embodiments of the present disclosure described herein can be implemented in a sequence except for those illustrated or described herein. In addition, the terms “comprising” and “having” and any variations thereof are intended to cover a non-exclusive inclusion.

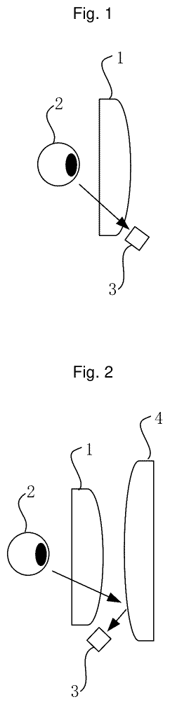

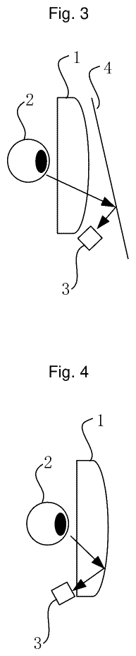

FIGS. 1-4 are diagrams of a light path of light ray to be imaged in the related technology, in the solution shown by FIG. 1, direct collection of an image is greatly affected by the volume of a light path, and meanwhile, in transmitting of a lens, total reflection easily occurs, so that collection cannot be carried out; in the solution shown by FIG. 2, another inside lens is adopted, the reflection effect is limited, targeted optimization cannot be carried out, and total reflection also easily occurs; in the solution shown by FIG. 3, due to adding of a reflector inside, space is severely limited, and a plurality of scenes cannot be realized; and in the solution shown in FIG. 4, the other face of an ocular lens is utilized for reflection, and due to limitation of a reflection face, it needs to be a convex face, as a concave face may have total reflection and cannot realize collection.

Aiming at the above problem, the present disclosure provides an eyeball tracking optical device and system, and a virtual reality device, the eyeball tracking optical device includes a light source assembly, a lens assembly, a reflection assembly and an image collection assembly; the lens assembly includes a first lens portion and a second lens portion which are sequentially disposed away from the eyeball, a side face, away from the eyeball, of the first lens portion has a concave face, a side face, close to the eyeball, of the second lens portion has a convex face, the concave face and the convex face attach to form a bonding face, the bonding face is provided with a first reflection layer, and the first lens portion and the second lens portion form a lens; the reflection assembly is located at the position, close to the image collection assembly, of the lens assembly; the light source assembly is disposed to emit a first light ray to the eyeball, the first reflection layer is disposed to reflect a reflection light ray of the first light ray to form first reflection a light ray, and the reflection assembly is disposed to reflect the first reflection light ray at least once to form a light ray to be imaged; and the image collection assembly is disposed to collect the light ray to be imaged, so as to track the eyeball. Therefore, by disposing the lens in the original lens assembly as the bonding lens and disposing the bonding face as the first reflection layer, the reflection light ray of the first light ray may be reflected to form the first reflection light ray, then the reflection assembly reflects the first reflection light ray at least once to form the light ray to be imaged, which are incident into the image collection assembly, so that the problem that originally, in the image collection part, the reflection light ray of the first light ray is easily completely reflected by the ocular lens or the added lens, and the image collection assembly cannot collect the light ray to be imaged is solved.

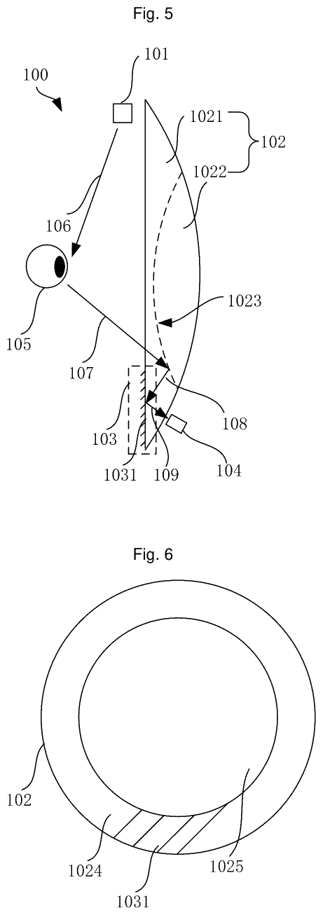

FIG. 5 is a principle diagram of a light path of an eyeball tracking optical device provided by the present disclosure. As shown in FIG. 5, the eyeball tracking optical device 100 includes a light source assembly 101, a lens assembly 102, a reflection assembly 103 and an image collection assembly 104.

The lens assembly 102 includes a first lens portion 1021 and a second lens portion 1022 which are sequentially disposed away from the eyeball 105, a side face, away from the eyeball 105, of the first lens portion 1021 has a concave face, a side face, close to the eyeball 105, of the second lens portion 1022 has a convex face, the concave face and the convex face attach to form a bonding face, the bonding face is provided with a first reflection layer 1023, and the first lens portion 1021 and the second lens portion 1022 form a bonding lens.

The reflection assembly 103 is located at the position, close to the image collection assembly 104, of the lens assembly 102.

The light source assembly 101 is disposed to emit a first light ray 106 to the eyeball 105, the first reflection layer 1023 is disposed to reflect a reflection light ray 107 of the first light ray 106 to form a first reflection light ray 108, and the reflection assembly 103 is disposed to reflect the first reflection light ray 108 at least once to form a light ray 109 to be imaged.

The image collection assembly 104 is disposed to collect the light ray 109 to be imaged, so as to track the eyeball 105.

It is to be noted that the light source assembly 101 may be disposed around the lens assembly 102, and the light source assembly 101 shown in FIG. 5 is only a part of it. The light source assembly 101 emits the first light ray 106 to the eyeball 105, then a facula is formed on the eyeball 105, the eyeball 105 reflects the first light ray 106 to form the reflection light ray 107, the reflection light ray 107 forms the first reflection light ray 108 through reflection of the first reflection layer 1023, through reflection of the reflection assembly 103, the first reflection light ray 108 form the light ray 109 to be imaged, which is incident into the image collection assembly 104, and the image collection assembly 104 images the light ray 109 to be imaged, so as to track the eyeball 105.

A concave face of the first lens portion 1021 and a convex face of the second lens portion 1022 attach to form a bonding face, and an attaching material may be a transparent optical adhesive, such as a polyimide material. The first lens portion 1021 and the second lens portion 1022 are different components of the same lens, and the first lens portion 1021 and the second lens portion 1022 form one lens (for example, an ocular lens) in a relevant device after attaching. In addition, the first reflection layer 1023 may reflect a light ray of a waveband emitted by the light source assembly 101. The first reflection layer 1023 may coat the concave face of the first lens portion 1021, and/or the convex face of the second lens portion 1022. In addition, an intermediate face type (curvature of the bonding face) of the first lens portion 1021 and the second lens portion 1022 may be optimized in a targeted manner at a design stage of a solution of an eyeball tracking light path, the refractive indexes of the first lens portion 1021 and the second lens portion 1022 are the same (or different, and the refractive index needs to be selected according to a specific use scene), and a reflection face type (generally a convex face, with convex facing the side of the eye) suitable for an application scene may be optimally found. The first reflection layer 1023 does not affect the presentation of a visual picture of a relevant device. The image collection assembly 104 may be a CMOS camera or a CCD camera, namely, the image collection assembly 104 may include one of a COMS or CCD photosensitive chip. At this point, while the image collection assembly 104 collects the image of the eyes, the design of the original light path system is not affected. Then, bonding of the first lens portion 1021 and the second lens portion 1022 is based on that the original design of the light path does not need to be changed, a new lens does not need to be added, the direction of the light path of the light ray to be imaged is changed, so that the device is compact in structure, and the problem that total reflection easily occurs in the related technology is solved.

The reflection assembly 103 is located at the position, close to the image collection assembly 104, of the lens assembly 102, and is configured to reflect again the first reflection light ray 108 formed by reflection of the first reflection layer 1023, so that outgoing of the first reflection light ray 108 from a side face, close to the eyeball 105, of the lens assembly 102 is avoided, which facilitates the image collection assembly 104 to be integrated inside the device.

Therefore, the arrangement of the reflection assembly 103 is convenient for position arrangement of the image collection assembly 104.

Optionally, as shown in FIG. 5, the reflection assembly 103 includes a second reflection layer 1031, and the second reflection layer 1031 attaches to part of the surface of one side, close to the eyeball 105, of the first lens portion 1021.

The second reflection layer 1031 may reflect a light ray of a waveband emitted by the light source assembly 101. Optionally, the second reflection layer 1031 is located in a non-visible area of the lens assembly 102.

As shown in FIG. 6, the lens assembly 102 has a visible area 1025 and a non-visible area 1024, the visible area 1025 is configured to present and display a picture when a user uses the device, and the non-visible area 1024 is an idle non-display frame area of the lens assembly 102. Then, the part (non-visible area 1024), close to the image collection assembly 104, of the bonding lens in the lens assembly 102 may be disposed as the second reflection layer 1031, so that the purpose that the first reflection light ray 108 to be reflected to form the light ray 109 to be imaged which emit from a side face, away from the eyeball, of the first lens portion 1021 is achieved, which facilitates arrangement of the image collection assembly 104 in the integral inside of the device, and overall integration of the device. The problem that the first reflection light ray 108 is emitted along a side face, close to the eyeball, of the bonding lens, consequently, the image collection assembly 104 needs to be mounted outside the device, and the size of the device is large is solved.

Therefore, due to the arrangement of the first reflection layer 1023 and the second reflection layer 1031, the original design of a light path of the first reflection light ray 108 is changed on the basis that a new lens is not added, and the problem that the reflection light ray 107 of the first light ray 106 easily have total reflection, so the image collection assembly 104 cannot collect a light ray to be imaged is solved.

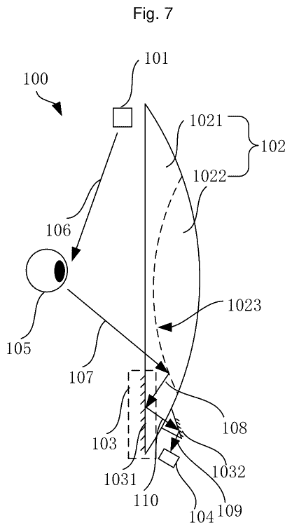

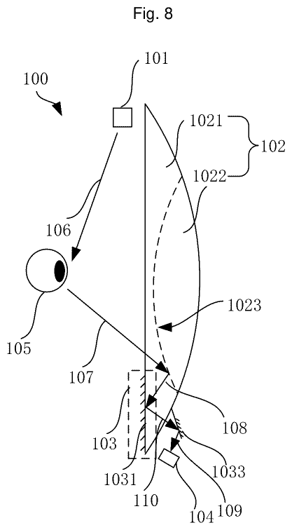

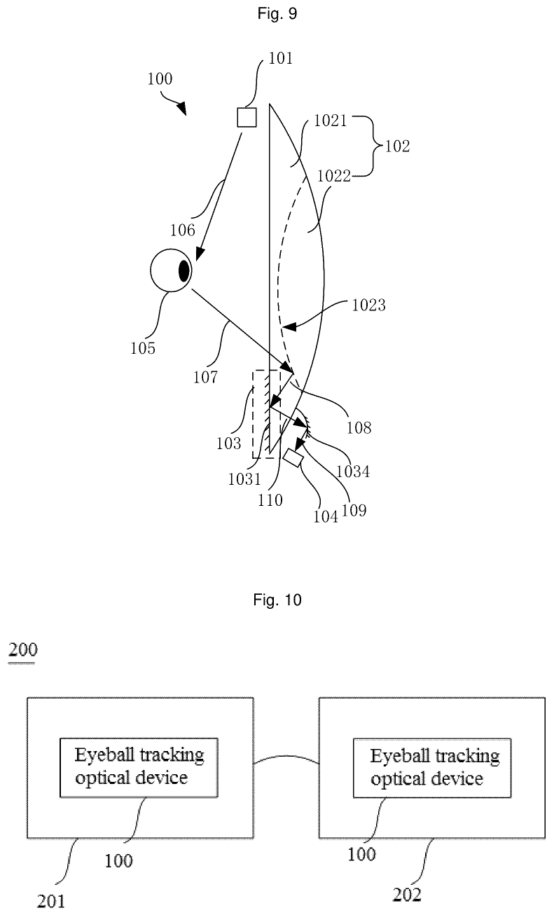

According to one embodiment of the present disclosure, as shown in FIGS. 7-9, the reflection assembly 103 further includes: at least one of a reflection prism 1032, a reflection plane mirror 1033 and a reflection curved mirror 1034, and is disposed to adjust the direction of second reflection a light ray 110 formed by reflection from the second reflection layer 1031, so as to form the light ray 109 to be imaged.

Optionally, one of the reflection prism 1032, the reflection plane mirror 1033 and the reflection curved mirror 1034 is disposed fixedly attaching to the first lens portion 1021. attaching may be realized by bonding using an optical adhesive.

As shown in FIGS. 7-9, a third reflection layer is disposed on one side of the reflection prism 1032, the reflection plane mirror 1033 or the reflection curved mirror 1034, second reflection the light ray 110 formed through reflection of the second reflection layer 1031 form the light ray 109 to be imaged through re-reflection of the third reflection layer after entering the reflection prism 1032, and the light ray 109 to be imaged are collected by the image collection assembly 104. Therefore, flexible arrangement of the position of the image collection assembly 104 is facilitated.

According to one embodiment of the present disclosure, the diameter of the concave face or the convex face is greater than or equal to that of the visible area 1025 of the lens assembly 102. Therefore, the edge of the bonding face is located in the non-visible area 1024 of the lens assembly 102, so as to avoid influence of the bonding edge on a visual picture in the visible area 1025. As shown in FIG. 6, the boundary of the visible area 1025 and the non-visible area 1024 may serve as the edge of outer contour of the bonding face.

Optionally, the light source assembly 101 is an infrared light source assembly, the first reflection layer 1023 is an infrared reflection layer, and the reflection assembly 103 is an infrared reflection assembly.

In all the embodiments above, the light source assembly 101 may be an infrared light source assembly, the first reflection layer 1023 may be an infrared reflection layer, the second reflection layer 1031 in the reflection assembly 103 may also be an infrared reflection layer, the third reflection layer disposed on one side of the reflection prism 1032, the reflection plane mirror 1033 or the reflection curved mirror 1034 in the reflection assembly 103 may also be an infrared reflection layer, and the infrared light source assembly may be a plurality of infrared LED lamps distributed around the lens assembly 102. The image collection assembly 104 may include a corresponding infrared imaging system.

Therefore, aiming at the solutions of the related technology shown in FIGS. 1-4, the corresponding problem of scene limitation exists in use, the bonding solution provided in the present disclosure may improve the problem, the bonding solution splits the ocular lens into two parts, the split face type may be optimized in a targeted manner to adapt to different use scenes, and the angle magnification is freely selected. Specifically, a use scene of a light path in FIG. 1 is limited, in a system with a short exit pupil distance, the image collection distance is too short to meet the requirement of a large field of view. For the eyeball tracking optical device provided by the present disclosure, by folding the light path to increase the length of the light path, the problem is solved. In FIG. 2, due to constraint of design of an original system, the reflection face of the original system cannot be optimized, so that a very good collection effect cannot be obtained. For the eyeball tracking optical device provided by the present disclosure, by optimizing the bonding face, the problem is well solved. In FIG. 3, adding of the reflector inside needs an air gap of at least 2 cm, many devices cannot meet the condition, while the eyeball tracking optical device provided by the present disclosure is not limited thereby. In FIG. 4, the second face of the ocular lens is generally a concave face, so that severe total reflection easily occurs, and the shooting effect may be rapidly deteriorated at the moment. The reflection face of the eyeball tracking optical device provided by the present disclosure may be a convex face, so that the problem is solved.

FIG. 10 is a schematic block diagram of an eyeball tracking optical system provided by the present disclosure. As shown in FIG. 10, the eyeball tracking optical system 200 includes two eyeball tracking optical devices 100 of any embodiment of the present disclosure, a left eye viewing assembly 201 and a right eye viewing assembly 202.

One eyeball tracking optical device 100 is mounted on the left eye viewing assembly 201.

The other eyeball tracking optical device 100 is mounted on the right eye viewing assembly 202.

The left eye viewing assembly 201 and the right eye viewing assembly 202 are symmetrically distributed left and right.

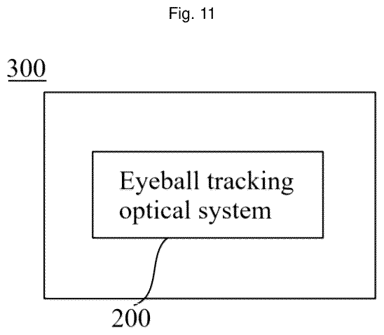

FIG. 11 is a schematic block diagram of a virtual reality device provided by the present disclosure. As shown in FIG. 11, the virtual reality device 300 includes the eyeball tracking optical system 200 provided by the present disclosure.

To sum up, according to the eyeball tracking optical device and system, and the virtual reality device provided by the present disclosure, the eyeball tracking optical device includes the light source assembly, the lens assembly, the reflection assembly and the image collection assembly; the lens assembly includes the first lens portion and the second lens portion which are sequentially disposed away from the eyeball, a side face, away from the eyeball, of the first lens portion has the concave face, a side face, close to the eyeball, of the second lens portion has the convex face, the concave face and the convex face attach to form the bonding face, the bonding face is provided with the first reflection layer, and the first lens portion and the second lens portion form the lens; the reflection assembly is located at the position, close to the image collection assembly, of the lens assembly; the light source assembly is disposed to emit the first light ray to the eyeball, the first reflection layer is disposed to reflect the reflection light ray of the first light ray to form the first reflection light ray, and the reflection assembly is disposed to reflect the first reflection light ray at least once to form the light ray to be imaged; and the image collection assembly is disposed to collect the light ray to be imaged, so as to track the eyeball. Therefore, by disposing the lens in the original lens assembly as the bonding lens and disposing the bonding face as the first reflection layer, the reflection light ray of the first light ray may be reflected to form the first reflection light ray, then the reflection assembly reflects the first reflection light ray at least once to form the light ray to be imaged, which are incident into the image collection assembly, so that the problem that originally, in the image collection part, the reflection light ray of the first light ray is easily completely reflected by the ocular lens or the added lens, and the image collection assembly cannot collect the light ray to be imaged is solved.

The above specific implementation modes should not be construed as limiting the space of the present disclosure. It should be understood by those skilled in the art that various modifications, combinations, sub-combinations and substitutions may be made, depending on design requirements and other factors. Any modifications, equivalent replacements, improvements and the like made within the spirit and principle of the present disclosure shall fall within the scope of protection of the present disclosure.

1. An eyeball tracking optical device, comprising a light source assembly, a lens assembly, a reflection assembly and an image collection assembly, wherein
the lens assembly comprises a first lens portion and a second lens portion which are sequentially disposed away from an eyeball, a side face, away from the eyeball, of the first lens portion has a concave face, a side face, close to the eyeball, of the second lens portion has a convex face, the concave face and the convex face attach to form a bonding face, the bonding face is provided with a first reflection layer, and the first lens portion and the second lens portion form a bonding lens;
the reflection assembly is located at a position, close to the image collection assembly, of the lens assembly;
the light source assembly is disposed to emit a first light ray to the eyeball, the first reflection layer is disposed to reflect a reflection light ray of the first light ray to form a first reflection light ray, and the reflection assembly is disposed to reflect the first reflection light ray at least once to form a light ray to be imaged;
the image collection assembly is disposed to collect the light ray to be imaged, so as to track the eyeball.

2. The eyeball tracking optical device according to claim 1, wherein the reflection assembly comprises a second reflection layer, and the second reflection layer attaches to a part of a surface of a side, close to the eyeball, of the first lens portion.

3. The eyeball tracking optical device according to claim 2, wherein the second reflection layer is located in a non-visible area of the lens assembly.

4. The eyeball tracking optical device according to claim 2, wherein the reflection assembly further comprises: at least one of a reflection prism, a reflection plane mirror and a reflection curved mirror, and is disposed to adjust a direction of a second reflection light ray formed by reflection from the second reflection layer, so as to form the light ray to be imaged.

5. The eyeball tracking optical device according to claim 4, wherein one of the reflection prism, the reflection plane mirror and the reflection curved mirror is disposed fixedly attaching to the first lens portion.

6. The eyeball tracking optical device according to claim 1, wherein a diameter of the concave face or the convex face is greater than or equal to a diameter of a visible area of the lens assembly.

7. The eyeball tracking optical device according to claim 1, wherein the light source assembly is an infrared light source assembly, the first reflection layer is an infrared reflection layer, and the reflection assembly is an infrared reflection assembly.

8. The eyeball tracking optical device according to claim 1, wherein the image collection assembly comprises one of a COMS or CCD photosensitive chip.

9. An eyeball tracking optical system, comprising two eyeball tracking optical devices according to claim 1, and
a left eye viewing assembly, one eyeball tracking optical device is mounted on the left eye viewing assembly;
a right eye viewing assembly, and the other eyeball tracking optical device is mounted on the right eye viewing assembly;
the left eye viewing assembly and the right eye viewing assembly are symmetrically distributed left and right.

10. A virtual reality device, comprising the eyeball tracking optical system according to claim 9.

11. The eyeball tracking optical device according to claim 2, wherein a diameter of the concave face or the convex face is greater than or equal to a diameter of a visible area of the lens assembly.

12. The eyeball tracking optical device according to claim 3, wherein a diameter of the concave face or the convex face is greater than or equal to a diameter of a visible area of the lens assembly.

13. The eyeball tracking optical device according to claim 4, wherein a diameter of the concave face or the convex face is greater than or equal to a diameter of a visible area of the lens assembly.

14. The eyeball tracking optical device according to claim 5, wherein a diameter of the concave face or the convex face is greater than or equal to a diameter of a visible area of the lens assembly.

15. The eyeball tracking optical device according to claim 2, wherein the light source assembly is an infrared light source assembly, the first reflection layer is an infrared reflection layer, and the reflection assembly is an infrared reflection assembly.

16. The eyeball tracking optical device according to claim 3, wherein the light source assembly is an infrared light source assembly, the first reflection layer is an infrared reflection layer, and the reflection assembly is an infrared reflection assembly.

17. The eyeball tracking optical device according to claim 4, wherein the light source assembly is an infrared light source assembly, the first reflection layer is an infrared reflection layer, and the reflection assembly is an infrared reflection assembly.

18. The eyeball tracking optical device according to claim 5, wherein the light source assembly is an infrared light source assembly, the first reflection layer is an infrared reflection layer, and the reflection assembly is an infrared reflection assembly.

19. The eyeball tracking optical device according to claim 2, wherein the image collection assembly comprises one of a COMS or CCD photosensitive chip.

20. The eyeball tracking optical device according to claim 3, wherein the image collection assembly comprises one of a COMS or CCD photosensitive chip.
